(19) United States
(12) Patent Application Publication
(10) Pub. No.: US 2013/0209144 A1
(43) Pub. Date: Aug. 15, 2013

(54) IMAGE FORMING APPARATUS

(71) Applicant: FUJI XEROX CO., LTD., (US)

(72) Inventors: Koichi WATANABE, Yokohama-shi (JP); Shuichi NISHIDE, Yokohama-shi (JP); Wataru SUZUKI, Ebina-shi (JP); Tetsuji OKAMOTO, Yokohama-shi (JP); Atsushi OGIHARA, Ebina-shi (JP); Masahiro SATO, Yokohama-shi (JP); Atsuyuki KITAMURA, Yokohama-shi (JP)

(73) Assignee: FUJI XEROX CO., LTD., Tokyo (JP)

(21) Appl. No.: 13/659,201

(22) Filed: Oct. 24, 2012

(30) Foreign Application Priority Data
Feb. 15, 2012 (JP) 2012-031009

(51) Int. Cl. G03G 15/01

(52) U.S. Cl. 399/304

(57) ABSTRACT

An image forming apparatus includes an image carrier, a transfer member, a leading end holding member, a trailing end holding member, and a movement mechanism. The trailing end holding member is disposed at a standby position such that there is a space between the trailing end holding member and the transfer member. The trailing end holding member is rotatable around the transfer member along a rotation path on which the standby position is located. In a multiple transfer operation, the trailing end holding member holds a trailing end of the recording medium after a leading end of the recording medium held by the leading end holding member has passed through the space. In a single transfer operation, the movement mechanism moves the trailing end holding member from the standby position to a position that is not on a transport path of the recording medium.

### CROSS-REFERENCE TO RELATED APPLICATIONS

This application is based on and claims priority under 35 USC 119 from Japanese Patent Application No. 2012-031009 filed Feb. 15, 2012.

### BACKGROUND

### Technical Field

The present invention relates to an image forming apparatus.

### SUMMARY

According to an aspect of the invention, an image forming apparatus includes an image carrier, a transfer member, a leading end holding member, a trailing end holding member, and a movement mechanism. The image carrier carries an image on an outer peripheral surface thereof. The transfer member is disposed such that an outer peripheral surface thereof is in contact with the outer peripheral surface of the image carrier. The transfer member transports a recording medium by rotating and transfers an image carried by the image carrier to the recording medium. The leading end holding member is disposed on the transfer member and holds a leading end of the recording medium so that the recording medium is wound around the outer peripheral surface of the transfer member. The trailing end holding member is disposed at a predetermined standby position such that there is a space between the trailing end holding member and the outer peripheral surface of the transfer member. The trailing end holding member is rotatable around the transfer member independently of the transfer member along a rotation path on which the standby position is located. The trailing end holding member holds a trailing end of the recording medium after the leading end of the recording medium held by the leading end holding member has passed through the space in a case of a multiple transfer operation with which images are transferred a plurality of times from the image carrier to the recording medium rotated by the transfer member while the recording medium is wound around the outer peripheral surface of the transfer member. The movement mechanism moves, in a case of a single transfer operation with which an image is transferred a single time from the image carrier to the recording medium, the trailing end holding member from the standby position to a position that is not on a transport path along which the recording medium passes during the single transfer operation.

### BRIEF DESCRIPTION OF THE DRAWINGS

An exemplary embodiment of the present invention will be described in detail based on the following figures, wherein:

FIG. 1 is a schematic view illustrating the structure of an image forming apparatus;

FIGS. 2A to 2C illustrate a color image forming operation;

FIGS. 3A to 3C illustrate the color image forming operation;

FIGS. 4A and 4B illustrate the color image forming operation;

FIGS. 5A to 5C illustrate a monochrome image forming operation;

FIGS. 6A to 6C illustrate the monochrome image forming operation;

FIGS. 7A and 7B illustrate the monochrome image forming operation;

FIGS. 8A to 8C illustrate a modification of the monochrome image forming operation;

FIGS. 9A to 9C illustrate the modification of the monochrome image forming operation; and

FIGS. 10A and 10B illustrate the modification of the monochrome image forming operation.

### DETAILED DESCRIPTION

Hereinafter, an exemplary embodiment of the present invention will be described with reference to the drawings.

### Structure of Image Forming Apparatus According to Present Exemplary Embodiment

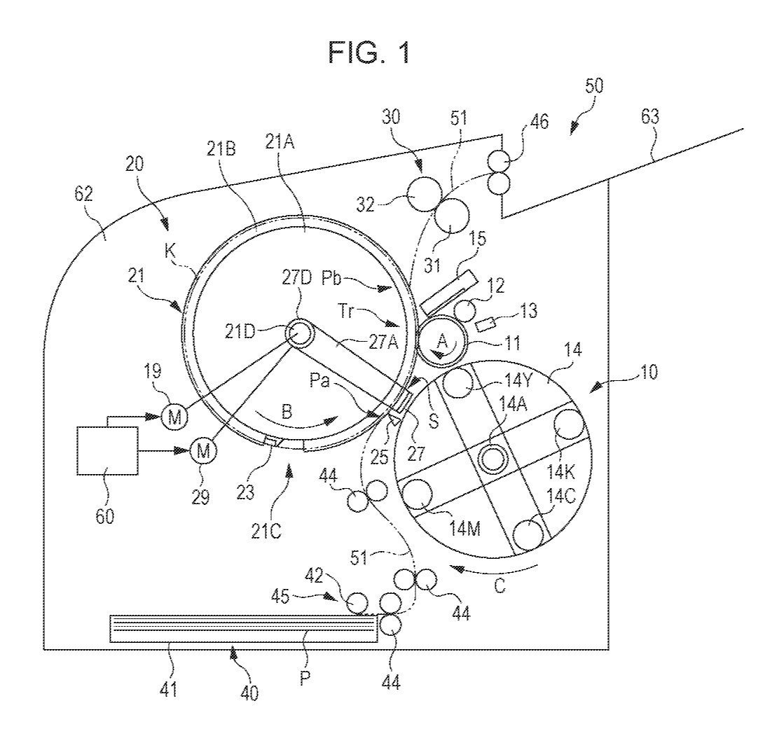

First, the structure of an image forming apparatus according to the present exemplary embodiment will be described. FIG. 1 is a schematic view illustrating the structure of an image forming apparatus 50 according to the present exemplary embodiment.

As illustrated in FIG. 1, the image forming apparatus 50 includes an image forming apparatus body 62 and various components disposed in the image forming apparatus body 62. An image forming unit 10, a recording medium feeder 40, and a controller 60 are disposed in the image forming apparatus body 62. The image forming unit 10 forms an image on a recording medium P, which is an example of a transported object. The recording medium feeder 40 feeds the recording medium P to the image forming unit 10. The controller 60 controls the operation of each component of the image forming apparatus 50. A recording medium output unit 63 is disposed on an upper part of the image forming apparatus body 62. After an image has been formed on the recording medium P by the image forming unit 10, the recording medium P is output to the recording medium output unit 63.

The recording medium feeder 40 includes a recording medium container 41 and a transport unit 45. The recording medium container 41 contains the recording medium P. The transport unit 45 transports the recording medium P from the recording medium container 41 to the image forming unit 10. The transport unit 45 includes a feed roller 42 and plural transport rollers 44. The feed roller 42 feeds the recording medium P contained in the recording medium container 41. The transport rollers 44 are arranged along a transport path 51 of the recording medium P and transport the recording medium P, which has been fed by the feed roller 42, to the image forming unit 10.

The image forming unit 10 includes a photoconductor drum 11 and a transfer device 20. The photoconductor drum 11 is an example of an image carrier that carries an image. The transfer device 20 transfers the image (toner image), which is carried by the photoconductor drum 11, to the recording medium P. The photoconductor drum 11 rotates in one direction (for example, the direction of arrow A in FIG. 1).

A charging roller 12, an exposure device 13, a rotary developing device 14, and a cleaner 15 are arranged around the photoconductor drum 11 in the rotation direction of the photoconductor drum 11. The charging roller 12, which is an example of a charger, charges the photoconductor drum 11. The exposure device 13 exposes the photoconductor drum 11, which has been charged by the charging roller 12, with light, and thereby forms an electrostatic latent image on the photoconductor drum 11. The rotary developing device 14, which is an example of a developing device, develops the electrostatic latent image, which has been formed on the photoconductor drum 11 by the exposure device 13, and thereby forms a toner image. The cleaner 15 cleans residual toner (developer) remaining on the photoconductor drum 11.

The exposure device 13 forms an electrostatic latent image on the basis of an image signal sent from the controller 60. Examples of an image signal sent from the controller 60 include an image signal received by the controller 60 from an external apparatus.

The rotary developing device 14 includes a rotation shaft 14A; and developing units 14Y, 14M, 14C, and 14K for yellow (Y), magenta (M), cyan (C), and black (K), which are arranged around the rotation shaft 14A in the circumferential direction of the rotation shaft 14A. The rotary developing device 14 rotates around the rotation shaft 14A in the direction of arrow C. When one of the developing units 14Y, 14M, 14C, and 14K of the rotary developing device 14 is located at a facing position at which the developing unit faces the photoconductor drum 11, an electrostatic latent image formed on the photoconductor drum 11 is developed by using a color toner corresponding to the developing unit located at the facing position, and thereby a toner image is formed.

The transfer device 20 includes a transfer drum 21 that is disposed such that the outer peripheral surface of the transfer drum 21 is in contact with the outer peripheral surface of the photoconductor drum 11. The transfer drum 21 transfers an image that is carried by the photoconductor drum 11 to the recording medium P. The transfer drum 21 is an example of a transfer member. In the transfer device 20, the recording medium P, which has been transported by the transport unit 45, is wound around the outer peripheral surface of the transfer drum 21 (to be specific, the outer peripheral surface of an elastic layer 21B described below), and rotates together with the photoconductor drum 11. As a result, the recording medium P is transported to a transfer position Tr (transfer region) between the transfer drum 21 and the photoconductor drum 11, and the transfer drum 21 transfers a toner image from the photoconductor drum 11 to the recording medium P. As described below, a leading end gripper 23 and a trailing end gripper 27 respectively grip the leading end and the trailing end of the recording medium P in the transport direction, and thereby the recording medium P is wound around the outer peripheral surface of the transfer drum 21.

The recording medium P is supplied to the transfer drum 21 at a supply position Pa shown in FIG. 1 (a holding-start position at which the leading end gripper 23 (described below) starts holding the recording medium P). The recording medium P is peeled off the transfer drum 21 at a peel-off position Pb shown in FIG. 1 (a holding-finish position at which the leading end gripper 23 finishes holding the recording medium P). The structure of the transfer device 20 will be described below in detail.

A fixing unit 30 is disposed downstream of (in FIG. 1, above) the transfer position Tr along the transport path 51. The fixing unit 30 fixes the toner image, which has been transferred to the recording medium P by the transfer device 20, to the recording medium P. The fixing unit 30 includes a heating roller 31 and a pressing roller 32. The heating roller 31 heats the toner image on the recording medium P. The pressing roller 32 presses the recording medium P as a result of being pressed against the heating roller 31.

In the fixing unit 30, the recording medium P is pressed and heated by the pressing roller 32 and the heating roller 31, which rotate with the recording medium P therebetween while transporting the recording medium P downstream (in FIG. 1, upward) along the transport path 51. As a result, the toner image is fixed to the recording medium P.

Output rollers 46 are disposed downstream of the fixing unit 30 along the transport path 51. The output rollers 46 output the recording medium P, to which the toner image has been fixed, to the recording medium output unit 63.

### Structure of Transfer Device 20 According to Present Exemplary Embodiment

Next, the structure of the transfer device 20 according to the present exemplary embodiment will be described.

As illustrated in FIG. 1, the transfer device 20 includes the transfer drum 21, the leading end gripper 23, and the trailing end gripper 27. The leading end gripper 23, which is an example of a leading end holding member, is disposed on the transfer drum 21 and grips the leading end of the recording medium P in the transport direction. The trailing end gripper 27, which is an example of a trailing end holding member, is disposed on the transfer drum 21 and grips the trailing end of the recording medium P in the transport direction.

A detection sensor 25 for detecting passage of the recording medium P is disposed so as to face the outer peripheral surface of the transfer drum 21. The detection sensor 25 is disposed upstream of a standby position (described below) of the trailing end gripper 27 (the position of the trailing end gripper 27 shown in FIG. 1) in the transport direction of the recording medium P.

### Transfer Drum 21

As illustrated in FIG. 1, the transfer drum 21 is disposed in the image forming apparatus body 62 so as to face the photoconductor drum 11 and so as to be rotatable around a rotation shaft 21D. The rotation shaft 21D is rotated by a drive motor 19 that is controlled by the controller 60, and thereby the transfer drum 21 rotates.

The transfer drum 21 includes a base member 21A having a cylindrical shape and the elastic layer 21B formed on the outer peripheral surface of the base member 21A. The base member 21A is electroconductive and is made of, for example, a metal material. The elastic layer 21B is made of a semi-conductive elastic material (for example, a resin material such as a polyurethane resin).

The transfer drum 21 rotates in the direction of arrow B in synchronism with the rotation of the photoconductor drum 11 while the elastic layer 21B is in contact with the photoconductor drum 11. A part of the elastic layer 21B that contacts the photoconductor drum 11 becomes elastically deformed.

A voltage (transfer bias) having a polarity opposite to that of toner is applied to the base member 21A of the transfer drum 21, and thereby a toner image is transferred from the photoconductor drum 11 to the recording medium P, which is wound around the elastic layer 21B, at the transfer position Tr.

A portion of the outer peripheral surface of the base member 21A in the circumferential direction is not covered with the elastic layer 21B. This portion, on which the elastic layer 21B is not disposed, will be referred to as a cutout portion 21C. That is, the cutout portion 21C, which is an example of a recess, is formed in the outer peripheral surface of the transfer drum 21. Even when the outer peripheral surface of the base member 21A in the cutout portion 21C faces the photoconductor drum 11, the outer peripheral surface does not contact the photoconductor drum 11. A non-conductive layer or the like may be formed on the outer peripheral surface of the base member 21A in the cutout portion 21C.

In FIG. 1, the outer periphery of the transfer drum 21 when the elastic layer 21B is elastically deformed is shown by two-dot chain line K. For clarity, the two-dot chain line K is drawn around the entire circumference of the transfer drum 21.

### Leading End Gripper 23

As illustrated in FIG. 1, the leading end gripper 23 is disposed in the cutout portion 21C of the transfer drum 21. The leading end gripper 23 rotates together with the transfer drum 21.

The leading end gripper 23 is rotatably supported by the transfer drum 21 (to be specific, the base member 21A) at a base end (a downstream end in the rotation direction of the transfer drum 21) of the leading end gripper 23. A tip end (an upstream end in the rotation direction of the transfer drum 21) of the leading end gripper 23 is capable of contacting and becoming separated from the outer peripheral surface of the transfer drum 21.

When the leading end gripper 23 rotates around the base end in a direction so that the tip end is separated from the outer peripheral surface of the transfer drum 21, the recording medium P may enter a space between the tip end and the outer peripheral surface of the transfer drum 21. When the leading end gripper 23 rotates around the base end in the opposite direction, the leading end gripper 23 holds the recording medium P between the tip end and the outer peripheral surface of the transfer drum 21.

The leading end gripper 23 has a plate-like shape extending in the axial direction of the transfer drum 21. The length of the leading end gripper 23 in the axial direction is larger than the maximum width of the recording medium P, which is wound around the transfer drum 21, in the axial direction of the transfer drum 21.

When the leading end gripper 23 is holding the recording medium P, the leading end gripper 23 is capable of passing the transfer position Tr without contacting the photoconductor drum 11. That is, when the leading end gripper 23 is holding the recording medium P, the leading end gripper 23 is located inside of the two-dot chain line K in FIG. 1.

### Trailing End Gripper 27

As illustrated in FIG. 1, the trailing end gripper 27 straddles the outer peripheral surface of the transfer drum 21 in the axial direction of the transfer drum 21. The trailing end gripper 27 is supported by support portions 27A disposed at ends of the transfer drum 21 in the axial direction so that the trailing end gripper 27 is capable of contacting and becoming separated from the outer peripheral surface of the transfer drum 21. When the trailing end gripper 27 is separated from the outer peripheral surface of the transfer drum 21, there is a space S between the trailing end gripper 27 and the outer peripheral surface of the transfer drum 21.

The support portions 27A are rotatably supported by a rotation shaft 27D that is coaxial with the rotation shaft 21D of the transfer drum 21. The rotation shaft 27D is rotated by a drive motor 29, which is an example of a movement mechanism, controlled by the controller 60. As a result, the trailing end gripper 27 rotates around (the outer periphery of) the transfer drum 21 independently of the transfer drum 21.

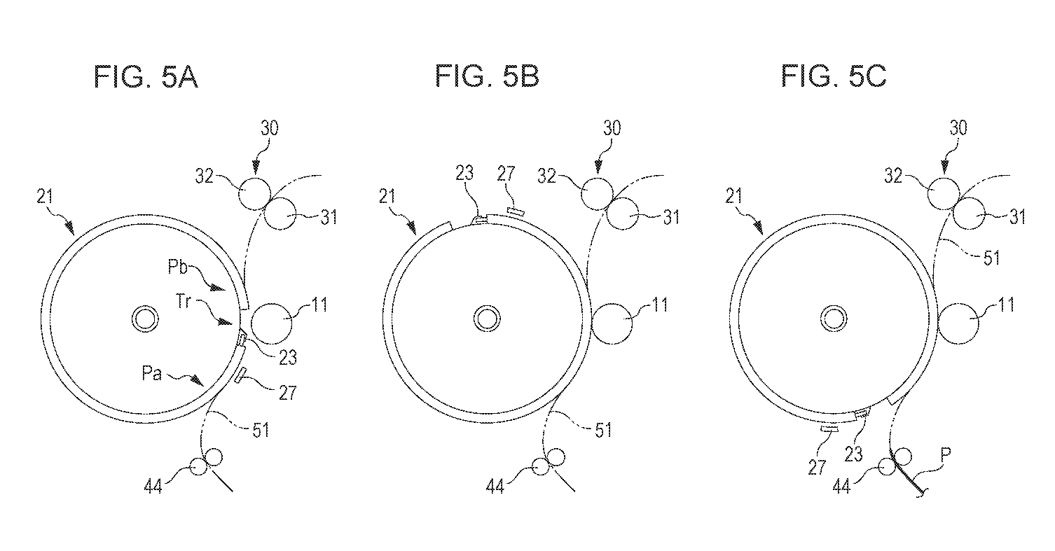

The trailing end gripper 27 is movable between a standby position (illustrated in FIGS. 1 and 5A) and a retracted position (illustrated in FIG. 5C), which are predetermined positions on the rotation path of the trailing end gripper 27. The standby position is a position at which the trailing end gripper 27 is located before the trailing end gripper 27 grips the recording medium P. The retracted position is a position at which the trailing end gripper 27 is retracted from the recording medium P that is being transported along the transport path 51. The standby position is, for example, a position on the transport path 51 between the transfer position Tr (transfer region) and the supply position Pa in the rotation direction of the transfer drum 21. The retracted position is a position that is not on the transport path 51 of the recording medium P (to be specific, the transport path along which the recording medium P passes when forming a monochrome image on the recording medium P).

The trailing end gripper 27 is made of a resin material (such as PET, a polyimide resin, or a fluorocarbon resin) and has a plate-like shape (film-like shape) extending in the axial direction of the transfer drum 21. The length of the trailing end gripper 27 in the axial direction is larger than the maximum width of the recording medium P (in the axial direction of the transfer drum 21), which is wound around the transfer drum 21. Alternatively, the trailing end gripper 27 may have a wire-like shape, a solid cylindrical shape, or the like.

When the detection sensor 25 detects passage of the trailing end of the recording medium P in the transport direction, the trailing end gripper 27 moves from a position in which the trailing end gripper 27 is separated from the transfer drum 21 to a position in which the trailing end gripper 27 contacts the transfer drum 21, and thereby holds the trailing end of the recording medium P by gripping the trailing end between the trailing end gripper 27 and the outer peripheral surface of the transfer drum 21 (to be specific, the outer peripheral surface of the elastic layer 21B).

As heretofore described, the leading end gripper 23 and the trailing end gripper 27 respectively grip the leading end and the trailing end of the recording medium P in the transport direction, and thereby the recording medium P is wound around the outer peripheral surface of the transfer drum 21.

### Operations According to Present Exemplary Embodiment

Next, operations according to the present exemplary embodiment will be described. Here, a case where the image forming apparatus 50 forms a color image on a recording medium P and a case where the image forming apparatus 50 forms a monochrome image on a recording medium P will be described.

The case of forming a color image on a recording medium P is an example of a multiple transfer operation. In this case, toner images are transferred plural times from the photoconductor drum 11 to a recording medium P that is rotated by the transfer drum 21 while being wound around the outer peripheral surface of the transfer drum 21. The case of forming a monochrome image on a recording medium P is an example of single transfer. In this case, a toner image is transferred a single time from the photoconductor drum 11 to a recording medium P. A black toner image or any other single-color toner image may be transferred in the case of single transfer.

### Color Image Forming Operation

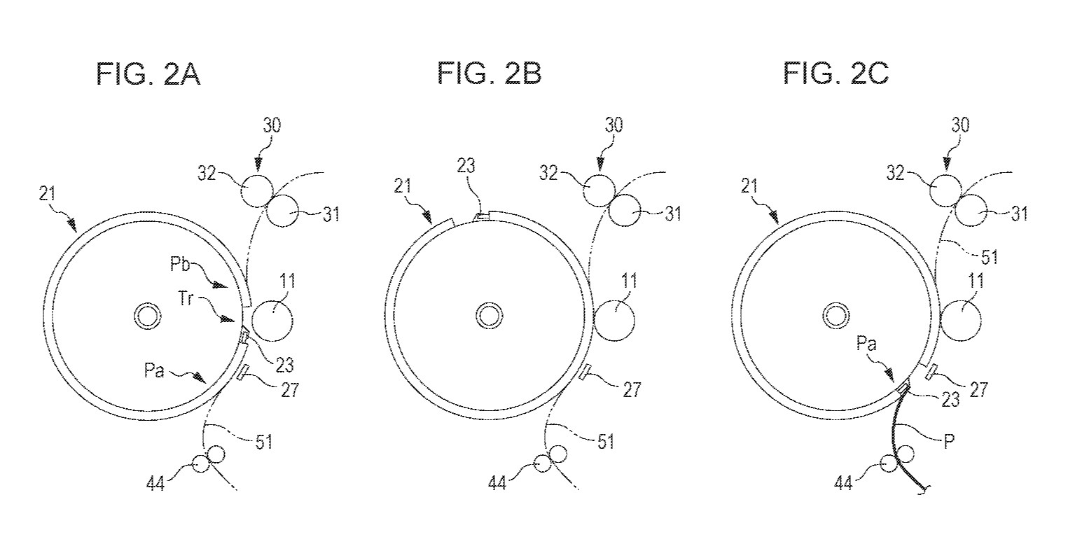

As illustrated in FIG. 2A, before a color image forming operation is started, the leading end gripper 23 is located at a standby position between the transfer position Tr and the supply position Pa in the rotation direction of the transfer drum 21. The trailing end gripper 27 is located at the standby position, which is located between the transfer position Tr and the supply position Pa. The standby position of the trailing end gripper 27 is upstream of the standby position of the leading end gripper 23 in the rotation direction of the transfer drum 21.

When the color image forming operation is started, the feed roller 42 feeds the recording medium P from the recording medium container 41, and the transport rollers 44 transport the recording medium P toward the transfer drum 21. As illustrated in FIG. 2B, while the recording medium P is transported toward the transfer drum 21, the transfer drum 21 rotates and the leading end gripper 23 moves from the standby position toward the supply position Pa. The transfer drum 21 is rotated by the drive motor 19 controlled by the controller 60 (see FIG. 1).

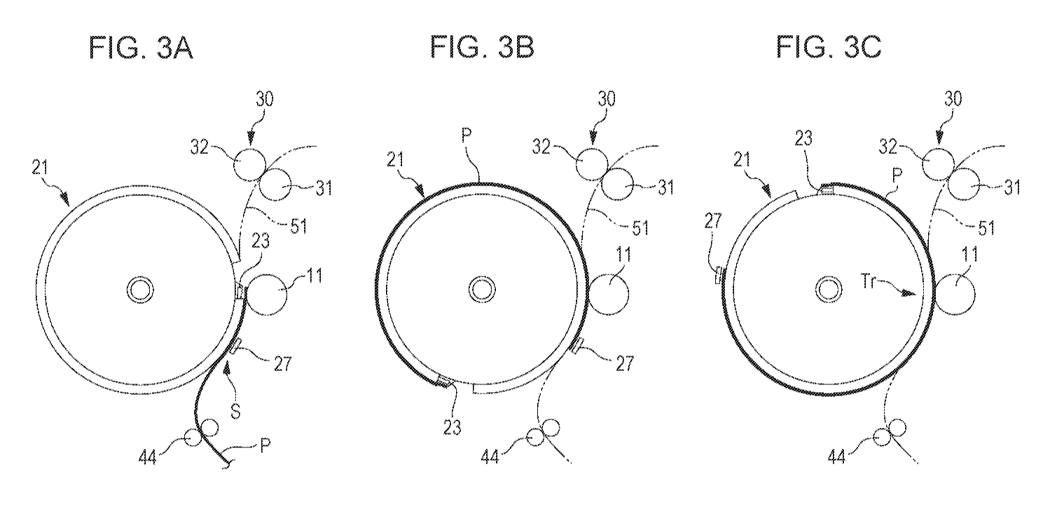

As illustrated in FIG. 2C, when the recording medium P has been transported to the transfer drum 21 by the transport rollers 44, the leading end gripper 23 grips the leading end of the recording medium P in the transport direction at the supply position Pa. As illustrated in FIG. 3A, while the transfer drum 21 rotates, the leading end of the recording medium P in the transport direction, which is gripped by the leading end gripper 23, passes through the space S between the transfer drum 21 and the trailing end gripper 27 located at the standby position. AS illustrated in FIG. 3B, when the detection sensor 25 (see FIG. 1) detects passage of the trailing end of the recording medium P in the transport direction after the leading end of the recording medium P in the transport direction has passed through the space S, the trailing end gripper 27 grips the trailing end of the recording medium P in the transport direction. Thus, the leading end gripper 23 and the trailing end gripper 27 respectively grip the leading end and the trailing end of the recording medium P in the transport direction, and thereby the recording medium P is wound around the outer peripheral surface of the transfer drum 21.

As illustrated in FIG. 3C, the transfer drum 21 and the trailing end gripper 27 rotate in synchronism with each other while the recording medium P is wound around the outer peripheral surface of the transfer drum 21, and thereby the recording medium P is rotated. Thus, the recording medium P is transported to the transfer position Tr. The trailing end gripper 27 is rotated by the drive motor 29 controlled by the controller 60 (see FIG. 1).

In the image forming unit 10 (see FIG. 1), the photoconductor drum 11 is charged by the charging roller 12 (charging) and exposed to light by the exposure device 13 (exposure), and thereby an electrostatic latent image is formed on the photoconductor drum 11. The electrostatic latent image is developed by the developing unit 14Y that faces the photoconductor drum 11, and thereby a yellow toner image is formed on the photoconductor drum 11 (development). The yellow toner image is transferred by the transfer drum 21 to the recording medium P, which has been transported to the transfer position Tr.

The transfer drum 21 and the trailing end gripper 27 rotate in synchronism with each other, and thereby rotate the recording medium P. The rotary developing device 14 rotates to a position at which the developing unit 14M faces the photoconductor drum 11. Charging, exposure, and development are performed as described above to form a magenta toner image on the photoconductor drum 11. The magenta toner image is transferred to the recording medium P, which is transported to the transfer position Tr again while the transfer drum 21 and the trailing end gripper 27 rotate. Likewise, cyan (C) and black (K) toner images are successively transferred to the recording medium P in an overlapping manner.

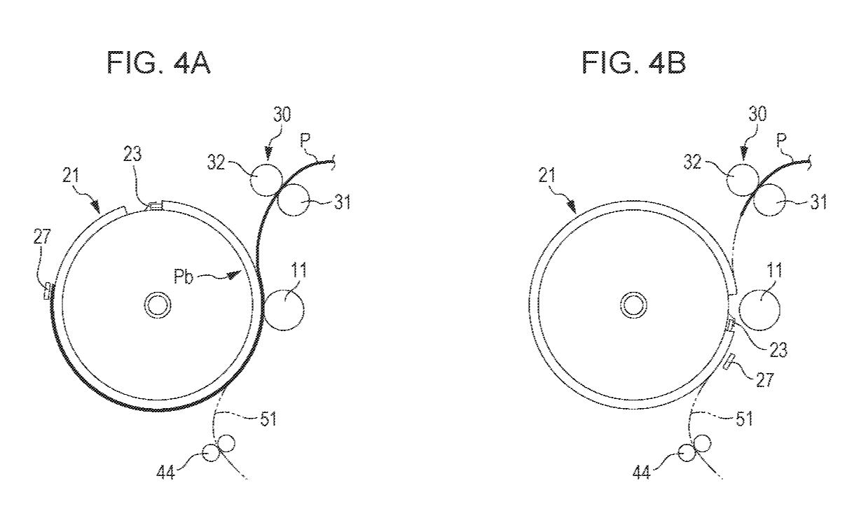

As illustrated in FIG. 4A, after the toner images have been transferred to the recording medium P in an overlapping manner, the leading end gripper 23 releases the leading end of the recording medium P in the transport direction at the peel-off position Pb, and thereby the recording medium P is peeled off the transfer drum 21.

As illustrated in FIG. 4B, the trailing end gripper 27 rotates to the standby position and releases the trailing end of the recording medium P in the transport direction and then waits at the standby position. The leading end gripper 23 rotates to the standby position together with the transfer drum 21 and waits at the standby position.

The recording medium P, which has been peeled off the transfer drum 21, is transported to the fixing unit 30, and the toner images are fixed to the recording medium P by the fixing unit 30. The recording medium P, on which the toner images have been fixed, is output to the recording medium output unit 63 by the output rollers 46. A color image forming operation is performed as heretofore described.

### Monochrome Image Forming Operation

As illustrated in FIG. 5A, before a monochrome image forming operation is started, the leading end gripper 23 is located at the standby position, which is located between the transfer position Tr and the supply position Pa in the rotation direction of the transfer drum 21. The trailing end gripper 27 is located at the standby position, which is located between the transfer position Tr and the supply position Pa and upstream of the standby position of the leading end gripper 23 in the rotation direction of the transfer drum 21.

When the monochrome image forming operation is started, the feed roller 42 feeds the recording medium P from the recording medium container 41, and the transport rollers 44 transport the recording medium P toward the transfer drum 21. As illustrated in FIG. 5B, while the recording medium P is being transported toward the transfer drum 21, the transfer drum 21 rotates and the leading end gripper 23 moves from the standby position toward the supply position Pa. The trailing end gripper 27 rotates in synchronism with rotation of the transfer drum 21 and moves from the standby position toward a retracted position that is not on the transport path 51 of the recording medium P.

As illustrated in FIG. 5C, when reaching the retracted position, the trailing end gripper 27 stops at the retracted position. On the other hand, the leading end gripper 23 continues moving toward the supply position Pa as the transfer drum 21 rotates.

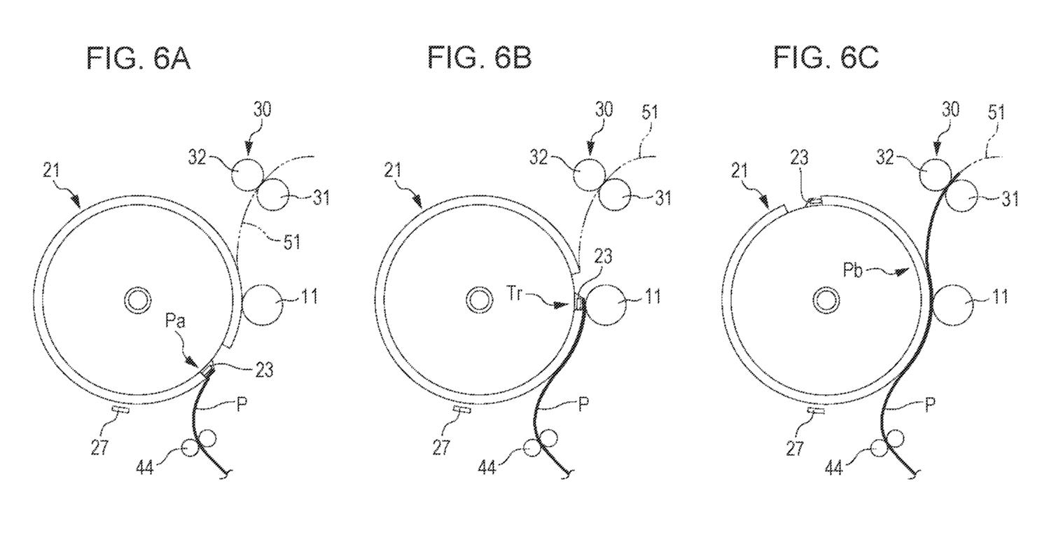

As illustrated in FIG. 6A, when the recording medium P has been transported to the transfer drum 21 by the transport rollers 44, the leading end gripper 23 grips the leading end of the recording medium P in the transport direction at the supply position Pa. As illustrated in FIG. 6B, the recording medium P, which is gripped by the leading end gripper 23, is transported to the transfer position Tr as the transfer drum 21 rotates.

In the image forming unit 10 (see FIG. 1), the photoconductor drum 11 is charged by the charging roller 12 (charging) and exposed to light by the exposure device 13 (exposure), and thereby an electrostatic latent image is formed on the photoconductor drum 11. The electrostatic latent image is developed by the developing unit 14K that faces the photoconductor drum 11, and thereby a black toner image is formed on the photoconductor drum 11 (development). The black toner image is transferred by the transfer drum 21 to the recording medium P, which has been transported to the transfer position Tr.

As illustrated in FIG. 6C, after the black toner image has been transferred to the recording medium P, the leading end gripper 23 releases the leading end of the recording medium P in the transport direction at the peel-off position Pb, and thereby the recording medium P is peeled off the transfer drum 21.

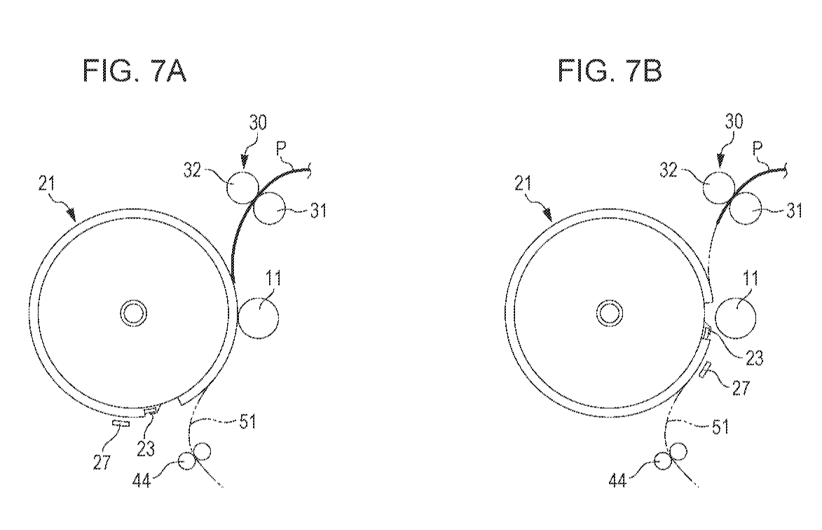

As illustrated in FIGS. 7A and 7B, even after the leading end gripper 23 has released the leading end of the recording medium P in the transport direction, the leading end gripper 23 continues rotating together with the transfer drum 21 to the standby position and waits at the standby position. After the recording medium P has passed the standby position of the trailing end gripper 27, the trailing end gripper 27 also continues rotating to the standby position and waits at the standby position.

The recording medium P, which has been peeled off the transfer drum 21, is transported to the fixing unit 30, and the toner image is fixed to the recording medium P by the fixing unit 30. The recording medium P, to which the toner image has been fixed, is output to the recording medium output unit 63 by the output rollers 46. A monochrome image forming operation is performed as heretofore described.

As described above, in a monochrome image forming operation, the trailing end gripper 27 retracts to the retracted position, which is not on the transport path 51 of the recording medium P. Therefore, the recording medium P does not contact the trailing end gripper 27 even if, for example, the leading end gripper 23 insufficiently grips the leading end of the recording medium P in the transport direction and the leading end of the recording medium P rises above the outer peripheral surface of the transfer drum 21 at a position upstream of the standby position of the trailing end gripper 27. As a result, the trailing end gripper 27 is prevented from being damaged.

Moreover, after the recording medium P has been transported, the leading end gripper 23 and the trailing end gripper 27 wait at their respective standby positions that are the same as those of a color image forming operation. Therefore, even when forming a color image after forming a monochrome image, the productivity does not decrease because it is not necessary to preliminarily move the leading end gripper 23 and the trailing end gripper 27 before forming the color image.

In the monochrome image forming operation described above, the trailing end gripper 27 moves to the retracted position by rotating in the direction of arrow B in FIG. 1. Instead, the trailing end gripper 27 may move to the retracted position by rotating in the opposite direction.

### Modification of Monochrome Image Forming Operation

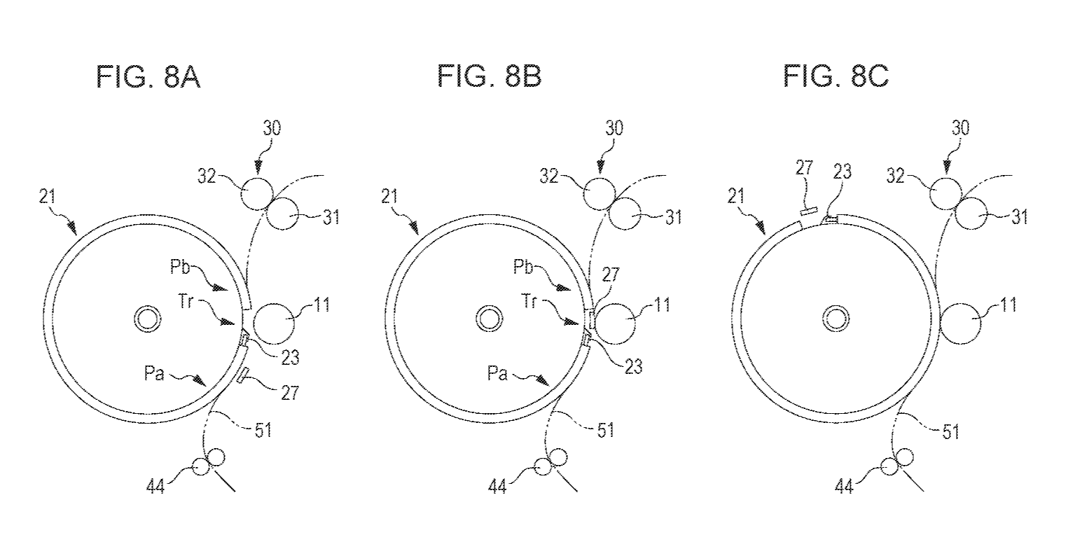

As illustrated in FIG. 8A, before a monochrome image forming operation is started, the leading end gripper 23 is located at the standby position between the transfer position Tr and the supply position Pa in the rotation direction of the transfer drum 21. The trailing end gripper 27 is located at the standby position between the transfer position Tr and the supply position Pa and upstream of the standby position of the leading end gripper 23 in the rotation direction of the transfer drum 21.

When the monochrome image forming operation is started, the feed roller 42 feeds the recording medium P from the recording medium container 41, and the transport rollers 44 transport the recording medium P toward the transfer drum 21.

As illustrated in FIG. 8B, while the recording medium P is being transported toward the transfer drum 21, the trailing end gripper 27 rotates and moves from the standby position toward a facing position at which the trailing end gripper 27 faces the cutout portion 21C of the transfer drum 21. As illustrated in FIG. 8C, after the trailing end gripper 27 has moved to the facing position, the transfer drum 21 and the trailing end gripper 27 rotate in synchronism with each other while the trailing end gripper 27 is in the facing position, and the leading end gripper 23 moves from the standby position toward the supply position Pa.

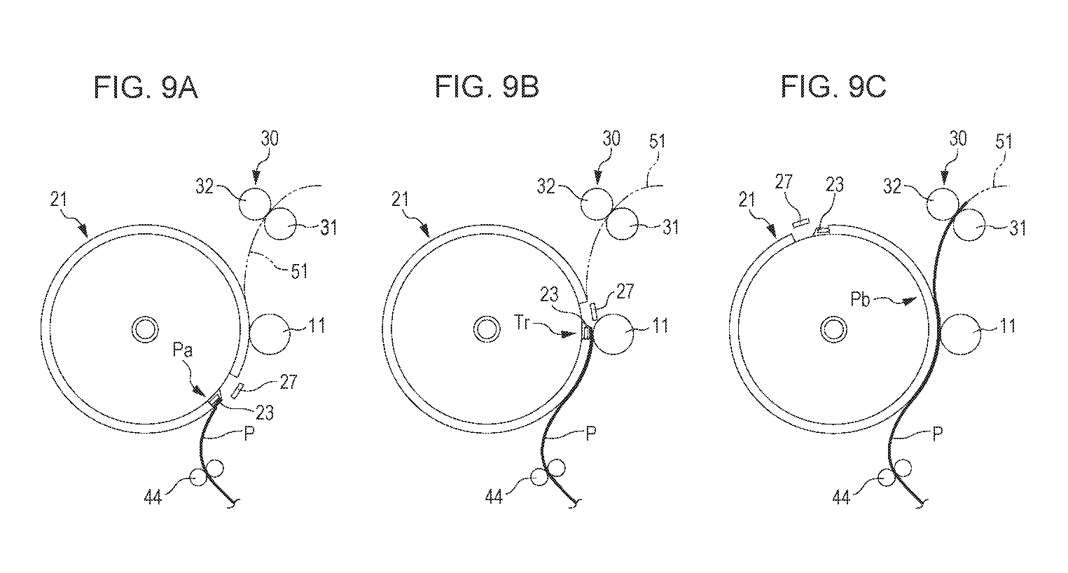

As illustrated in FIG. 9A, when the recording medium P has been transported to the transfer drum 21 by the transport rollers 44, the leading end gripper 23 grips the leading end of the recording medium P in the transport direction at the supply position Pa. As illustrated in FIG. 9B, the recording medium P, which is gripped by the leading end gripper 23, is transported to the transfer position Tr while the transfer drum 21 rotates.

In the image forming unit 10 (see FIG. 1), the photoconductor drum 11 is charged by the charging roller 12 (charging) and exposed to light by the exposure device 13 (exposure), and thereby an electrostatic latent image is formed on the photoconductor drum 11. The electrostatic latent image is developed by the developing unit 14K that faces the photoconductor drum 11, and thereby a black toner image is formed on the photoconductor drum 11 (development). The black toner image is transferred by the transfer drum 21 to the recording medium P, which has been transported to the transfer position Tr.

As illustrated in FIG. 9C, after the black toner image has been transferred to the recording medium P, the leading end gripper 23 releases the leading end of the recording medium P in the transport direction at the peel-off position Pb, and thereby the recording medium P is peeled off the transfer drum 21.

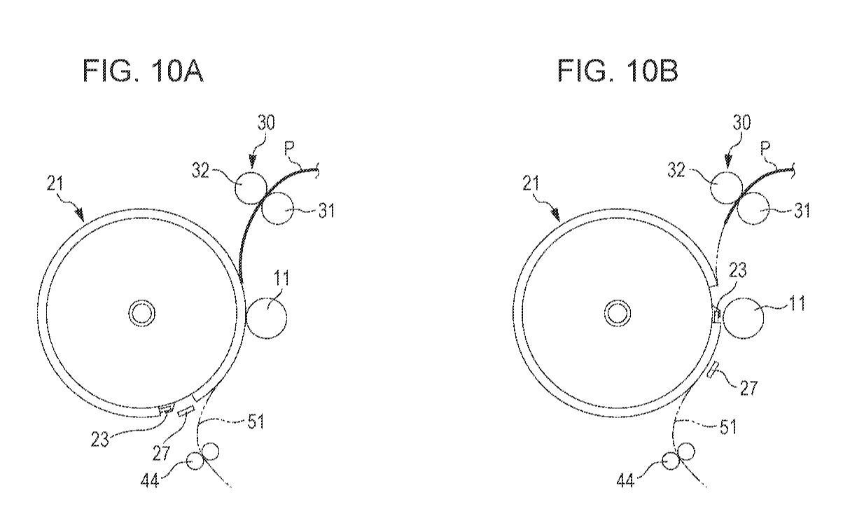

As illustrated in FIGS. 10A and 10B, even after the leading end gripper 23 has released the leading end of the recording medium P in the transport direction, the transfer drum 21 and the trailing end gripper 27 continue to rotate in synchronism with each other until the leading end gripper 23 and the trailing end gripper 27 reach their respective standby positions. Then, the leading end gripper 23 and the trailing end gripper 27 wait at the standby positions.

The recording medium P, which has been peeled off the transfer drum 21, is transported to the fixing unit 30, and the toner image is fixed to the recording medium P by the fixing unit 30. The recording medium P, to which the toner image has been fixed, is output to the recording medium output unit 63 by the output rollers 46. A monochrome image forming operation is performed as heretofore described.

As described above, also in a monochrome image forming operation according to the modification, the trailing end gripper 27 retracts to a retracted position that is not on the transport path 51 of the recording medium P. Therefore, the recording medium P does not contact the trailing end gripper 27 even if, for example, the leading end gripper 23 insufficiently grips the leading end of the recording medium P in the transport direction and the leading end of the recording medium P rises above the outer peripheral surface of the transfer drum 21 at a position upstream of the standby position of the trailing end gripper 27. As a result, the trailing end gripper 27 is prevented from being damaged.

Moreover, after the recording medium P has been transported, the leading end gripper 23 and the trailing end gripper 27 wait at their respective standby positions that are the same as those of a color image forming operation. Therefore, even when forming a color image after forming a monochrome image, the productivity does not decrease because it is not necessary to preliminarily move the leading end gripper 23 and the trailing end gripper 27 before forming the color image.

In the monochrome image forming operation according to the modification, the trailing end gripper 27 rotates in synchronism with rotation of the transfer drum 21. Therefore, damage to the trailing end gripper 27, which may occur when the transfer drum 21 and the trailing end gripper 27 rub against each other, is prevented.

In the monochrome image forming operation according to the modification, the trailing end gripper 27 rotates together with the transfer drum 21 while facing the cutout portion 21C (recess) of the transfer drum 21. Therefore, friction between the trailing end gripper 27 and the photoconductor drum 11 is low when the trailing end gripper 27 passes the transfer position Tr, and damage to the photoconductor drum 11 and the trailing end gripper 27, which may occur when the photoconductor drum 11 and the trailing end gripper 27 rub against each other, is prevented.

In the monochrome image forming operation according to the modification, the trailing end gripper 27 faces the cutout portion 21C. Alternatively, the trailing end gripper 27 may rotate in synchronism with rotation of the transfer drum 21 while facing a portion of the outer peripheral surface of the transfer drum 21 over which the recording medium P is not wound.

The present invention is not limited to the exemplary embodiment described above and may be modified, changed, and improved in various ways. For example, the modifications described above may be used in combination.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that carries an image on an outer peripheral surface thereof;
a transfer member disposed such that an outer peripheral surface thereof is in contact with the outer peripheral surface of the image carrier, the transfer member transporting a recording medium by rotating, the transfer member transferring an image carried by the image carrier to the recording medium;
a leading end holding member disposed on the transfer member and holding a leading end of the recording medium so that the recording medium is wound around the outer peripheral surface of the transfer member;
a trailing end holding member disposed at a predetermined standby position such that there is a space between the trailing end holding member and the outer peripheral surface of the transfer member, the trailing end holding member being rotatable around the transfer member independently of the transfer member along a rotation path on which the standby position is located, the trailing end holding member holding a trailing end of the recording medium after the leading end of the recording medium held by the leading end holding member has passed through the space in a case of a multiple transfer operation with which images are transferred a plurality of times from the image carrier to the recording medium rotated by the transfer member while the recording medium is wound around the outer peripheral surface of the transfer member; and
a movement mechanism that moves, in a case of a single transfer operation with which an image is transferred a single time from the image carrier to the recording medium, the trailing end holding member from the standby position to a position that is not on a transport path along which the recording medium passes during the single transfer operation.

2. The image forming apparatus according to claim 1,
wherein the movement mechanism rotates the trailing end holding member in synchronism with rotation of the transfer member while the trailing end holding member is facing a portion of the outer peripheral surface of the transfer member on which the recording medium is not wound.

3. The image forming apparatus according to claim 2,
wherein the movement mechanism rotates the trailing end holding member in synchronism with rotation of the transfer member while the trailing end holding member is facing a recess formed in the outer peripheral surface of the transfer member.

4. The image forming apparatus according to claim 1,
wherein the movement mechanism moves the trailing end holding member to the standby position after an image has been transferred to the recording medium in the case of the single transfer operation.

5. The image forming apparatus according to claim 2,
wherein the movement mechanism moves the trailing end holding member to the standby position after an image has been transferred to the recording medium in the case of the single transfer operation.

6. The image forming apparatus according to claim 3,
wherein the movement mechanism moves the trailing end holding member to the standby position after an image has been transferred to the recording medium in the case of the single transfer operation.
